(19) United States
(12) Patent Application Publication
(10) Pub. No.: US 2011/0025902 A1
(43) Pub. Date: Feb. 3, 2011

(54) SYSTEM FOR ZOOMING AN OBJECT / OBJECTS AND HOLDING THEREOF IN A VISION ZONE

(76) Inventor: Vladimir Vitalievich Miroshnichenko, Moscow Region (RU)

Correspondence Address: Aleksandr Smushkovich, POB 140505, Brooklyn, NY, 11214, US

(21) Appl. No.: 12/736,421

(22) PCT Filed: Apr. 3, 2009
(86) PCT No.: PCT/RU2009/000159

§ 371 Date: Oct. 7, 2010

(30) Foreign Application Priority Data
Apr. 10, 2008 (RU) 2008113632

(51) Int. Cl. H04N 5/225

(52) U.S. Cl. 348/335; 348/E05.024

(57) ABSTRACT

A system for zooming and holding an image of an object/objects in a vision zone is proposed. The vision zone comprises—a first sector having a first zoom factor, first size, first contour, and first position, and—a second sector having a second zoom factor, second size, second contour, and second position. The second zoom factor may differ from the first one. The first sector can be disposed inside of the second sector, the contours may have or may not have a common point. The system is capable of—changing the first and second zoom factors independently, and/or—respectively decreasing/increasing the first size in response to decreasing/increasing the second size and vice-versa, and/or—changing the sectors' positions. In some embodiments, the vision zone comprises multiple sectors. The system can be built employing conventional optical/optoelectronic components/technologies, and associated with optical/electronic or optical-electronic sights, binoculars, video/photo cameras (including digital ones), etc.

### CROSS-REFERENCE TO RELATED APPLICATIONS

This application is a U.S. national stage application of a PCT application PCT/RU2009/000159 filed on 3 Apr. 2009, whose disclosure is incorporated herein in its entirety by reference, which PCT application claims priority of a Russian Federation application RU2008113632 filed on 10 Apr. 2008. This U.S. national stage application also contains parts of disclosure absent in PCT/RU2009/000159.

### FIELD OF THE INVENTION

The present invention relates to systems and devices for zooming (i.e. magnification of) a visual image of an object or objects and holding the image in a zone of vision (herein also called a ‘vision zone’ that may include two or more visual sectors) of optical/electronic/optical-electronic sights, binoculars, video and photo cameras (including digital video and photo cameras), and similar devices.

### BACKGROUND OF THE INVENTION

There are different technologies applied in contemporary optical sights. Some optical sights are provided for improvement of the shooting in complicated weather conditions. Such sights have polarizing filters or coatings. Other sights are provided for night shooting and are based on heat radiation in the infrared spectrum.

An optical sight is characterized with a zoom factor (also known as a ‘magnification ratio’), e.g. a tenfold sight zooms an object in ten times. Depending on the situation, a shooter selects the zoom factor he/she needs.

Contemporary optical sights generally have a common problem: although the resolution of an object's image increases with an increase of the zoom factor, the vision zone simultaneously decreases that complicates targeting.

Another problem a shooter faces when using an optical sight with a high zoom factor is that it is very difficult to ‘capture’ a moving target and to hold its image in the sight.

In video cameras and photo cameras there is a similar problem of holding a moving object's image in the vision zone.

The closest related art solutions are described in U.S. Pat. No. 4,483,598, U.S. Patent Applications 2007/0146528, 2007/0171238, and 2007/0188860. These solutions provide the opportunity to have a vision zone consisting of two sectors with different zoom factors (a ‘lower’ and a ‘higher’ zoom factors). However, these solutions have the following disadvantages:
1) inability to change the zoom factor of the sector with a higher zoom factor and the zoom factor of the sector with a lower zoom factor independently of each other;
2) the sector with a higher zoom factor cannot change its size, namely to be increased or decreased, respectively, in response to decreasing or increasing the sector with a lower zoom factor;
3) the central sector cannot have a zoom factor less than the external sector.

### BRIEF DESCRIPTION OF DRAWINGS

FIG. 1 shows a schematic view of a vision zone consisting of two visual sectors of an optical system, wherein one visual sector is disposed entirely inside the other, and the visual sectors have different zoom factors, according to an exemplary embodiment of the present invention.

FIG. 2 shows a schematic view of a vision zone consisting of two visual sectors of a photo/video camera, wherein one visual sector is disposed entirely inside the other, and the visual sectors have different zoom factors, according to another exemplary embodiment of the present invention.

FIG. 3 shows a schematic view of a vision zone consisting of two visual sectors of a photo/video camera, wherein one visual sector is disposed inside the other, the two sectors have their own peripheral contours, however, these peripheral contours have a common portion (herein also called a ‘common line section’), and the visual sectors have different zoom factors, according to another exemplary embodiment of the present invention.

### OBJECTIVES AND DESCRIPTION OF THE INVENTION

The above-mentioned disadvantages can be eliminated to a large extent by the inventive system for zooming an image of an object/objects and holding thereof in a vision zone, described herein below. According to the invention, in a visual device, such as an optical (as well as an electronic or optical-electronic) sight, binoculars, photo and video cameras, the vision zone includes at least two visual sectors with a higher and a lower zoom factors that are used at the same time.

For instance, in the center of an optical sight, a shooter sees a visual sector with a higher zoom factor surrounded by a visual sector with a lower zoom factor. At the expense of the sector with the lower zoom factor, an angle of view of the optical sight is increased that allows easier and faster finding the target (object). When the target appears in the sector with the lower zoom factor, the shooter aims the central sector with the higher zoom factor at the target, which is seen more distinct in this visual sector, and then shoots at the object.

If the object moves, it will possibly leave the central sector with the higher zoom factor, but will remain in the visual sector with the lower zoom factor, and the shooter will be able to capture the object in the sector with the higher zoom factor to make a shot.

The visual device can be optical, or electronic, or optical-electronic. In an electronic sight the image is shown on a display. An increase of the higher zoom factor of the central sector is achieved with the help of a special computer program. In an optical-electronic sight, only the central sector is displayed on the screen, on which the increase of the zoom factor of the central sector is achieved by using a special computer program.

In binoculars, digital video cameras and digital photo cameras, the inventive system also employs the above described principle. Exemplarily, visual sectors with a higher and a lower zoom factors appear on a display, where information about an image of an object is delivered by a special computer program, which also enables better holding the image in the vision zone, especially when this object moves.

The sector with a higher zoom factor can be of a various shape (a circle, a square, etc.). In the mentioned visual devices, the sector with a lower zoom factor doesn't necessarily surround the sector with a higher zoom factor.

A distinct feature of the invention is that it allows the operator of a visual device to change the zoom factor of the central (or generally, ‘internal’) sector with a higher zoom factor and the external sector with a lower zoom factor. Due to the changes of zoom factor of the central and the external sectors, the external sector may become the sector with a higher zoom factor and the central sector may become the sector with a lower zoom factor. The changes allow for optimal adjusting the sectors' zoom factors according to individual requirements of the operator.

Furthermore, it is possible to change the size and the position of the sector with a higher zoom factor, namely to increase or decrease its size and/or position in response to respectively decreasing or increasing the size and/or the position of the sector with a lower zoom factor. Alternatively, the zoom factors of the central and external sectors can be changed independently of each other, according to individual requirements of the operator.

The invention also includes a possibility to have one and more sectors with a higher zoom factor and one and more sectors with a lower zoom factor.

Therefore, a primary objective of the proposed invention is to improve the currently known systems for zooming and holding an image of an object/objects (often, moving targets) in a vision zone of optical, electronic, or optical-electronic sights, binoculars, photo and video cameras (including digital ones) that can preferably be composed of optical and/or optoelectronic components. Other objectives can be discovered and utilized by those skilled in the art upon learning the present disclosure.

The aforesaid improvement has been achieved by providing a newly designed system for zooming and holding an image of an object/objects in a vision zone, while the vision zone is part of the system.

In some embodiments, the vision zone comprises: —an internal visual sector having a first zoom factor, a first size, and a first peripheral contour; and—an external visual sector having a second zoom factor, a second size, and a second peripheral contour; wherein either: the internal visual sector is disposed entirely inside of the external visual sector, so that the first peripheral contour has no common point with the second peripheral contour; or the internal visual sector is disposed inside of the external visual sector, so that the first peripheral contour has at least one common point (or a common line section) with the second peripheral contour; and wherein the system is so configured that is capable of: (a) changing the first and the second zoom factors independently of each other; and/or (b) respectively decreasing or increasing the first size in response to decreasing or increasing the second size and vice-versa.

In some more specific embodiments, the aforesaid system is preferably composed of optical and/or optoelectronic components.

The aforesaid first zoom factor can be set greater than the aforesaid second zoom factor, or vice-versa.

In other specific embodiments, the internal visual sector has a first position and the external visual sector has a second position; and the system is so configured that is capable of changing the first position relatively to the second position, either independently, or in response to changing the second position, and vice-versa.

The inventive system may preferably be associated with an optical sight, or an electronic sight, or an optical-electronic sight, or a binocular, or a display of a photo camera (including a digital photo camera), or a display of a video camera (including a digital video camera), or a similar device.

In other embodiments of the inventive system (further also called a ‘system with multiple visual sectors’), the vision zone comprises: —a plurality of internal visual sectors, each sector of the plurality of internal visual sectors has a first zoom factor, a first size, and a first peripheral contour; and—a plurality of external visual sectors, each sector of the plurality of external visual sectors has a second zoom factor, a second size, and a second peripheral contour; wherein—either: each sector of the plurality of internal visual sectors is disposed entirely inside of a corresponding sector of the plurality of external visual sectors, thereby forming a couple of sectors, so that the first peripheral contour has no common point with the corresponding second peripheral contour; —or each sector of the plurality of internal visual sectors is disposed inside of a corresponding sector of the plurality of external visual sectors, thereby forming a couple of sectors, so that the first peripheral contour has at least one common point (or a common line section) with the corresponding second peripheral contour; and wherein the system is so configured that is capable of: (a) changing the first and the second zoom factors of each aforesaid couple of sectors independently of each other; and/or (b) respectively decreasing or increasing the first size of each aforesaid couple of sectors in response to decreasing or increasing the second size, and vice-versa.

In some more specific embodiments, the aforementioned system with multiple visual sectors is preferably composed of optical and/or optoelectronic components.

In some more specific embodiments of the aforementioned system with multiple visual sectors, the aforesaid first zoom factor can be set greater than the second zoom factor, or vice-versa.

In other specific embodiments of the aforementioned system with multiple visual sectors, for any couple of sectors, the internal visual sector has a first position and the external visual sector has a second position; and the system is so configured that is capable of changing the first position relatively to the second position, either independently, or in response to changing the second position, and vice-versa.

Yet, in other embodiments, the vision zone comprises: —a first visual sector having a first zoom factor, a first size, and a first position; and—a second visual sector having a second zoom factor, a second size, and a second position; wherein the system is so configured that is capable of: (a) changing the first and the second zoom factors independently of each other; and/or (b) respectively decreasing or increasing the first size in response to decreasing or increasing the second size and vice-versa; and/or (c) changing the first position relatively to the second position either independently, or in response to changing the second position, and vice-versa. In these embodiments, the mutual disposition of the first and second sectors can be arbitrary.

### DETAIL DESCRIPTION OF EXEMPLARY EMBODIMENTS

While the invention may be susceptible to embodiment in different forms, there are described in detail herein below, specific embodiments of the present invention, with the understanding that the present disclosure is to be considered an exemplification of the principles of the invention, and is not intended to limit the invention to that as illustrated and described herein.

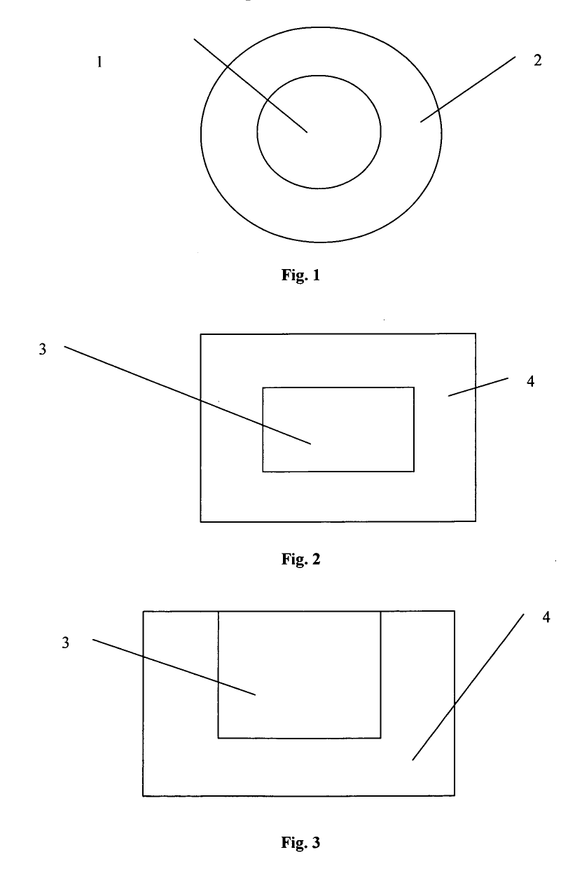

According to an exemplary embodiment of the present invention, FIG. 1 shows a schematic view of a vision zone consisting of two visual sectors of an optical system, wherein one visual sector (internal visual sector) (1) is disposed entirely inside another visual sector (external visual sector) (2), and the visual sector (1) has a greater zoom factor than a zoom factor of the visual sector (2). In this embodiment, the visual sectors have a circular shape.

According to another exemplary embodiment of the present invention, FIG. 2 shows a schematic view of a vision zone consisting of two visual sectors of a photo/video camera, wherein an internal visual sector (3) is disposed entirely inside an external visual sector (4), and the internal visual sector (3) has a zoom factor greater than a zoom factor of the external visual sector (4). In this embodiment, the visual sectors have a rectangular shape.

According to another exemplary embodiment of the present invention, FIG. 3 shows a schematic view of a vision zone consisting of two visual sectors of a photo/video camera, wherein an internal visual sector (3) is disposed inside an external visual sector (4), the two sectors have their own peripheral contours of a rectangular shape. These peripheral contours have a common line section, i.e. the upper side of sector (3) coincides with a certain portion of the upper side of sector (4). The internal visual sector (3) has a zoom factor greater than a zoom factor of the external visual sector (4).

### APPLICATIONS OF THE INVENTION

The inventive system can be built employing conventional optical/optoelectronic components and computer programs for digital photo and video cameras. It also can be built employing conventional optical components for optical sights and binoculars. The inventive system disclosed herein can be successfully applied in the mentioned or similar types of visual devices.

1. A system for zooming an image of an object or objects and holding thereof in a vision zone, said vision zone being part of said system, said vision zone comprising:
an internal visual sector having a first zoom factor, a first size, and a first peripheral contour; and
an external visual sector having a second zoom factor, a second size, and a second peripheral contour;
wherein
either:
said internal visual sector is disposed entirely inside of said external visual sector, so that the first peripheral contour has no common point with the second peripheral contour;
or
said internal visual sector is disposed inside of said external visual sector, so that the first peripheral contour has at least one common point with the second peripheral contour;
and wherein
said system is so configured that is capable of:
(a) changing the first and the second zoom factors independently of each other; and/or
(b) respectively decreasing or increasing the first size in response to decreasing or increasing the second size and vice-versa.

2. The system according to claim 1, wherein said system is composed of optical and/or optoelectronic components.

3. The system according to claim 1, wherein the first zoom factor is greater than the second zoom factor.

4. The system according to claim 1, wherein the second zoom factor is greater than the first zoom factor.

5. The system according to claim 1, wherein said internal visual sector has a first position and said external visual sector has a second position; and said system is so configured that is capable of changing the first position relatively to the second position and vice-versa.

6. The system according to claim 1, further associated with an optical sight, or an electronic sight, or an optical-electronic sight, or a binocular, or a display of a photo camera, or a display of a video camera.

7. A system for zooming an image of an object or objects and holding thereof in a vision zone, said vision zone being part of said system, said vision zone comprising:
a plurality of internal visual sectors, each sector of said plurality of internal visual sectors having a first zoom factor, a first size, and a first peripheral contour; and
a plurality of external visual sectors, each sector of said plurality of external visual sectors having a second zoom factor, a second size, and a second peripheral contour;
wherein
either:
each sector of said plurality of internal visual sectors is disposed entirely inside of a corresponding sector of said plurality of external visual sectors, thereby forming a couple of sectors, so that the first peripheral contour has no common point with the corresponding second peripheral contour;
or
each sector of said plurality of internal visual sectors is disposed inside of a corresponding sector of said plurality of external visual sectors, thereby forming a couple of sectors, so that the first peripheral contour has at least one common point with the corresponding second peripheral contour;
and wherein
said system is so configured that is capable of:
(a) changing the first and the second zoom factors of each said couple of sectors independently of each other; and/or
(b) respectively decreasing or increasing the first size of each said couple of sectors in response to decreasing or increasing the second size of the said couple, and vice-versa.

8. The system according to claim 7, wherein said system is composed of optical and/or optoelectronic components.

9. The system according to claim 7, wherein, for each said couple of sectors, the first zoom factor is greater than the second zoom factor.

10. The system according to claim 7, wherein, for each said couple of sectors, the second zoom factor is greater than the first zoom factor.

11. The system according to claim 7, wherein, for each said couple of sectors, said internal visual sector has a first position and said external visual sector has a second position; and said system is so configured that is capable of changing the first position relatively to the second position, and vice-versa.

12. A system for zooming an image of an object or objects and holding thereof in a vision zone, said vision zone being part of said system, said vision zone comprising:
a first visual sector having a first zoom factor, a first size, and a first position; and
a second visual sector having a second zoom factor, a second size, and a second position;
wherein said system is so configured that is capable of:
(a) changing the first and the second zoom factors independently of each other; and/or
(b) respectively decreasing or increasing the first size in response to decreasing or increasing the second size and vice-versa; and/or
(c) changing the first position relatively the second position and vice-versa.
